(19) United States
(12) Patent Application Publication
(10) Pub. No.: US 2017/0293982 A1
(43) Pub. Date: Oct. 12, 2017

(54) METHODS AND APPARATUS FOR PROCESSING A PURCHASE

(71) Applicant: MasterCard International Incorporated, Purchase, NY (US)

(72) Inventors: Ashutosh Kumar Gupta, Uttar Pradesh (IN); Ankur Arora, New Delhi (IN); Rohit Modi, New Delhi (IN)

(21) Appl. No.: 15/446,639

(22) Filed: Mar. 1, 2017

(30) Foreign Application Priority Data
Apr. 6, 2016 (SG) 10201602712U

(51) Int. Cl. G06Q 50/06; G06Q 30/06; G06Q 20/36

(52) U.S. Cl. CPC G06Q 50/06; G06Q 20/3674; G06Q 30/0635; G06Q 30/0631

(57) ABSTRACT

Methods and devices for processing a payment transaction for a purchase carried out by a vehicle user with a merchant are provided. The method comprises a server (a) obtaining a vehicle ID, from a vehicle detection unit, upon a vehicle entering a premise of the merchant; (b) interrogating a database using the vehicle ID to obtain a device identifier associated with a communication device of the user; (c) transmitting the device identifier to a wallet server over a communication network; (d) receiving, upon authorization by the wallet server, over the communication network wallet information associated with a digital wallet of the user; (e) receiving, via the communication device, product information indicative of one or more product items ordered by the user; and (f) transmitting a transaction request to a payment network to cause a payment transaction in respect of the one or more products to be processed, said transaction request comprising the wallet information. A communication device and the associated method for the above process are also disclosed.

### CROSS-REFERENCE TO RELATED APPLICATION

This application is a U.S. National Stage filing under 35 U.S.C. §119, based on and claiming benefit of and priority to SG Patent Application No. 10201602712U filed Apr. 6, 2016.

### FIELD AND BACKGROUND

The present disclosure relates to methods and apparatus for processing a purchase. In particular, computerized-methods and devices are provided for making purchases and processing payment transactions for purchases made by a vehicle user.

Vehicle users make regularly visits to fuel stations to purchase petrol, diesel or other types of motor fuel for their vehicles. Conventionally, a vehicle user drives to a fuel kiosk of a fuel station and asks a staff for a specific amount of fuel of a specific type to be supplied to the vehicle. The consumer (i.e. vehicle user) then gives cash or a cashless payment device (typically a card) to the staff to make a payment for the purchase. The consumer leaves the fuel station when it is confirmed that the transaction is completed. This may be time-consuming for the consumer as the entire transaction process may take long, and the problem becomes more prominent when the traffic at the fuel station is large (i.e. when a lot of vehicles await at the fuel station to purchase the fuel).

Therefore, it is desirable to provide improved methods and apparatus to make the above process more efficient and hassle-free for vehicle users.

### SUMMARY

The present disclosure provides methods and apparatus for making purchases and processing payment transactions for purchases made by a vehicle user, especially at a merchant which supplies products (e.g. goods and/or services) associated with a vehicle, or products for use in the course of the consumer driving the vehicle. In general terms, the present disclosure proposes associating a vehicle identification number (a vehicle ID) with a device identifier associated with a communication device of the vehicle user and identifying wallet information using the device identifier to complete a payment transaction for a purchase made by the vehicle user.

According to a first aspect, there is provided a method of processing a payment transaction for a purchase carried out by a vehicle user with a merchant, the method comprising a server:

(a) obtaining a vehicle ID, from a vehicle detection unit, upon a vehicle entering a premise of the merchant;
(b) interrogating a database using the vehicle ID to obtain a device identifier associated with a communication device of the user;
(c) transmitting the device identifier to a wallet server over a communication network;
(d) receiving, upon authorization by the wallet server, over the communication network wallet information associated with a digital wallet of the user;
(e) receiving, via the communication device, product information indicative of one or more product items ordered by the user; and
(f) transmitting a transaction request to a payment network to cause a payment transaction in respect of the one or more products to be processed, said transaction request comprising the wallet information.

A digital wallet typically stores or is otherwise linked to payment account information associated with a payment card (such as a credit card or debit card) which an owner holds. In some embodiments, a digital wallet may be configured to receive pre-paid funds (e.g. from an owner's bank account). The owner may select an amount to pay into the digital wallet (e.g. on an ad hoc, daily, weekly, monthly, quarterly or annual basis). The digital wallet may also store other commerce-related information, such as delivery address details, loyalty program information, and the like.

The wallet server typically stores (or otherwise in communication with) a wallet database of digital wallets. The wallet database stores an association between a digital wallet of the owner and a registered device identifier associated with a communication device of the owner (e.g. the owner's mobile phone number). The wallet server is configured to access the wallet database to identify one or more digital wallets using the registered device identifier associated with the owner. The wallet server may be a cloud server.

For example, by obtaining a mobile phone number of the user based on a vehicle ID, the method allows wallet data of all digital wallets associated with this mobile phone number to be identified. In other words, if the user has more than one digital wallet associated with the mobile phone number, the method allows those digital wallets to be identified so that any one of them may be selected by the user for making a payment for the purchase. Comparing to having a predefined one-to-one correspondence between a particular digital wallet and a vehicle, the method offers the user flexibility in choosing which digital wallet he/she likes to use to for a particular transaction, and/or a transaction with a particular merchant. Therefore, the method may be especially useful for circumstances in which a user holds a plurality of digital wallets at respective wallet service providers.

Note that although the device identifier in the above example is a mobile phone number of the user's communication device. In some embodiments, other types of device identifiers may also be used to identify the communication device, for example, an Android ID, an iOS device's Universal Device ID (UDID), an Advertising ID, an International Mobile Subscriber Identity (IMSI), an International Mobile Equipment Identity (IMEI), an Integrated Circuit Card ID (ICCID) or the like.

Typically, but not necessarily, the method described above is performed by a server of the merchant. The database stores a predefined association between each of a plurality of vehicle IDs and the respective device identifier. Ideally, the vehicle ID should allow the vehicle to be uniquely identified, or uniquely identified within a context such as a geographic region.

In one embodiment, the database is stored within the server. In another embodiment, the database could be in a remote location, which is accessible to the server via a communication network.

In one embodiment, operation (e) may comprise transmitting a product list having a plurality of candidate product items to the communication device for selection by the user. The product information received by the server describes the one or more product items selected by the user. Usually, the product list also comprises price information for the respective candidate product items.

In one embodiment, the candidate product items may comprise a product item recommended for the user based on past transaction records. Additionally or alternatively, the candidate product items may comprise a product item recommended for the user based on vehicle data received by the server.

In one example, the vehicle data is fuel data describing a current fuel level of the vehicle. The vehicle data may additionally or alternatively comprise a fuel type by which the vehicle is powered. For example, a predefined association between each of the vehicle IDs and a respective fuel type by which the vehicle is powered may be stored by a database accessible by the server.

In one embodiment, the candidate product items may represent two or more options to purchase fuel of different quantities. In another possibility, the candidate product items may represent two or more options to purchase fuel of different types, such as gasoline (including different grades of gasoline characterized by its octane rating) or diesel.

In one embodiment, at least one of the candidate product items is food or beverage supplied by the merchant.

The method may comprise obtaining a geographic location of the communication device. The geographic location of the communication device may be compared against a geographic location of the merchant. The method may comprise performing operation (f) only if the two are determined to be consistent with each other. This reduces the risk of fraudulent transactions by verifying that the vehicle user who holds the digital wallet is physically present at the merchant's premise to make the purchase.

Operation (f) may be carried out in the form of a known electronic transaction whereby the merchant server sends a transaction request to the payment network via a payment gateway. An acquirer system then processes the request and transmits it to an issuer system at which the user holds the payment account. Once approved by the issuer system, the payment is cleared and settled, and funds are transferred to the acquirer system for storing in the merchant account. Non-limiting examples of the payment network are a payment card type of network such as the payment processing network operated by MasterCard, Inc.

In some embodiments, the geographic location of the communication device may be included in the transaction request transmitted to a payment network server. The verification may then be carried out by the payment network server, as a part of a payment authorization process.

The method may further comprise generating a notification to notify the communication device and or the merchant server upon the payment transaction being successful.

According to a second aspect, there is provided a computer server for processing a payment transaction for a purchase carried out by a vehicle user with a merchant. The computer server comprises a server processor, a data storage device storing server processor program instructions. The server processor program instructions are operative to cause the server processor to perform any one of the methods described above.

The present disclosure further proposes a server software product, such as at a time when it is stored in a non-transitory form on a tangible data storage device. The data storage device may be within the server, or it may be a database from which the server is able to download the software. In particular, there is proposed a server program product comprising computer program instructions which is operative, when implemented by a processor of a server, to cause the processor to perform any one of the methods described above.

The present disclosure also provides a method of making a payment for a purchase carried out by a vehicle user with a merchant. The method comprises a communication device (such as a mobile phone) of the vehicle user, upon a vehicle ID having been obtained at a premise of the merchant:

(g) receiving, from a wallet server, wallet data identifying one or more digital wallets associated with the vehicle user;
(h) registering a wallet selection from the one or more digital wallets and causing wallet information associated with the selected wallet to be transmitted to a server of the merchant;
(i) registering one or more product items ordered by the user, and
(j) transmitting the one or more product items to the merchant's server to initiate a payment transaction for the one or more product items using the selected wallet.

Operation (b) may be include an authorization step in which the wallet server receives an authorization from the user to transmit the wallet information to the merchant's server. Such a step may further require the user authenticate his/her identity as the true wallet holder of the digital wallet against an authentication database storing password, or biometric data of the user such as voice recognition or a retina or fingerprint data. For example, the method may require the user to input a PIN or his/her biometric information through an input terminal (such as via a GUI) of the communication device.

Additionally or alternatively, operation (b) may further comprise causing the wallet information to be transmitted upon a geographic location of the communication device being successfully verified against a geographic location of the merchant. This may be achieved by transmitting the geographic location of the communication device to a server which validates that the geographic location of the communication device is consistent with at least one of geographic locations of the merchant and the vehicle. This adds additional security protection to the transaction thereby minimizing unauthorized transactions such that, for example, a user of a stolen vehicle would not be able to transact with the merchant using a digital wallet of the rightful vehicle owner or user.

Typically, operation (d) involves causing the server of the merchant to submit a transaction request comprising the wallet information of the selected wallet to a payment network.

According to a further aspect, there is provided a communication device for making a payment for purchases carried out by a user of a vehicle. The communication device has a processor and a data storage device storing program instructions. The computer program instructions are operative, upon a vehicle ID having been obtained at a premise of the merchant, to cause the processor to perform any one of the methods described above.

The invention may be expressed in terms of the software product itself, such as at a time when it is stored in non-transitory form on a tangible data storage device. The data storage device may be within the communication device, or it may be a database from which the communication is able to download the software application.

As used in this document, the term “payment card” refers to any suitable cashless payment device, such as a credit card, a debit card, a prepaid card, a charge card, a membership card, a promotional card, a frequent flyer card, an identification card, a gift card, and/or any other device that may hold payment account information, such as mobile phones, Smartphones, personal digital assistants (PDAs), key fobs, transponder devices, NFC-enabled devices, tablets and/or computers.

As used in this document, the term “product” is used in this document to include any of goods or services.

### BRIEF DESCRIPTION OF THE DRAWINGS

Embodiments of the present disclosures will now be described for the sake of non-limiting example only, with reference to the following drawings in which:

FIG. 1 shows schematically a computerized network which is suitable to perform a method which is an embodiment;

FIG. 2 is a flow diagram of a method according to an embodiment;

FIG. 3 illustrates a product list according to one embodiment;

FIG. 4 shows schematically another computerized network which is suitable to perform the method which is another embodiment;

FIG. 5 shows the technical architecture of a computer server of the computerized network of FIG. 1 and FIG. 4; and

FIG. 6 shows the technical architecture of a communication device of the computerized network of FIG. 1 and FIG. 4.

### DETAILED DESCRIPTION

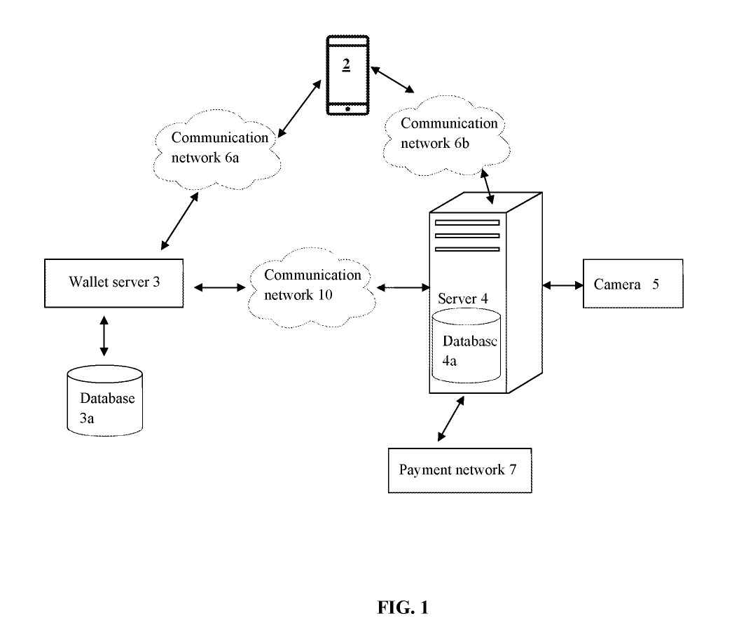

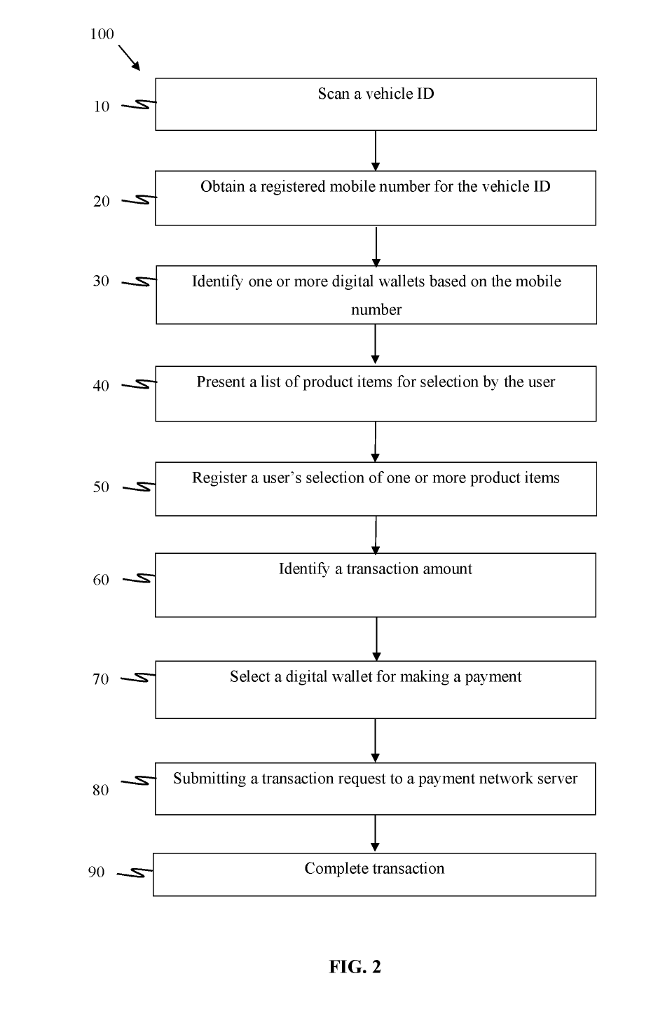

Referring to FIG. 1, a computerized network is shown which is suitable for performing a method of an embodiment as illustrated by FIG. 2.

The embodiments below will be illustrated with respect to transactions carried out by vehicle users at a fuel station that supplies motor fuel to vehicles. It will be understood that the method may apply to any other merchant offering a different type of products to vehicles too.

The computerized network comprises a merchant server 4 in communication with a wallet server 3, a communication device 2 of a vehicle user and a payment network 7. The merchant server 4 is configured to receive an input from a vehicle detection unit (in form of a camera 5 for example), upon the vehicle detection unit reading data associated with a vehicle that is at or approaching the merchant's premise.

In this example, the vehicle detection unit comprises an optical reader (e.g. the camera 5) which captures a vehicle identification number of the vehicle, such a vehicle plate number of the vehicle. The vehicle plate number may be extracted from an image taken of an exterior of the vehicle. It will be understood that the vehicle detection unit may be any other scanning device configured to identify the vehicle, for example, an RFID scanner which identifies a vehicle based on an RFID tag attached to the vehicle.

The wallet server 3 is accessible to a wallet database 3a (which is remote to the wallet server 3) that stores a predefined association between each of a plurality digital wallets and a respective registered mobile phone number of a holder of the digital wallet. Note that a mobile phone number may be associated with one or more digital wallets, as a user may hold more than one digital wallet. In another embodiment, the wallet database 3a is stored by the wallet server 3. It will be understood that the wallet database 3a may store a predefined association between digital wallets and another type of device identifier associated with the user's communication device.

The merchant server 4 comprises or is communicatively coupled with a database 4a which stores a predefined association between a plurality of vehicle IDs and respective mobile phone numbers. The database 4a may be established via a registration process requesting vehicle users to provide a vehicle identification number and a mobile phone number beforehand. The merchant server 4 may be located in close proximity to the actual retail premise of the merchant, or remote to it.

The communication device 2 may be a smartphone, a smart watch, a tablet computer or the like. The communication device 2 has an associated mobile phone number, which uniquely identifies a mobile phone user's subscription in a mobile telephony network. The mobile phone number is typically the MSISSDN (Mobile Station International Subscriber Directory Number), which is the telephone number to the SIM card in a mobile phone. It is envisaged that a smart watch or a tablet computer of a user may be associated with a mobile phone number of a mobile phone of the same user, even if the device itself is not SIM enabled. The association between the tablet computer and the mobile phone number may be established by the user specifying an association the two devices for example, by pairing the devices up using a dedicated communication network with access control, such as by Bluetooth™. In a variant, the association may be established by the user logging onto the devices the using a same or corresponding account information registered at an account service provider. In other words, it is envisaged that the communication device 2 may be an Apple Watch or an iPad of an iPhone user and they are associated with the mobile phone number of the iPhone by a same Apple ID across the devices.

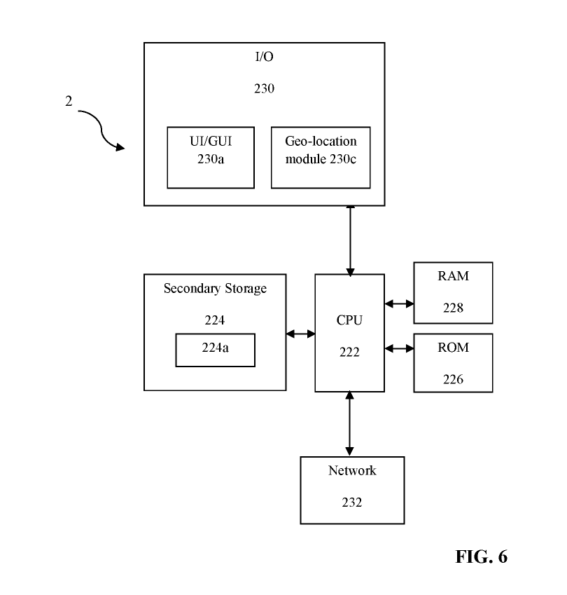

It is also envisaged that in some embodiments the communication device may not be SIM card enabled to access to a cellular network such as a 3G or 4G network. The communication device may instead have a network connectivity device 232 (as illustrated with respect to FIG. 6) which allows for network connection via wi-fi or Bluetooth hotspot at the merchant premise.

Each of the merchant server 4, the wallet server 3 and the communication device 2 has a communication module such as a wireless interface for two-way communication between one and another via communication networks 10, 6a, 6b.

The communication networks 6a, 6b, 10 may be any types of network, for example, virtual private network (VPN), the Internet, a local area and/or wide area network (LAN and/or WAN), a wi-fi network, or a 3G or 4G telecommunication network.

FIG. 2 illustrates a flow of an exemplary method 100 of the present disclosure.

In operation 10, the camera 5 captures an image of a vehicle upon the vehicle entering the merchant's premise. A vehicle plate number of the vehicle is identified from the image, for example, using optical character recognition (OCR) techniques. The vehicle plate number is then transmitted to the merchant server 4. Alternatively, the merchant server 4 may receive the image and extract the vehicle plate number itself by analyzing the image using known image processing techniques.

In some embodiments, vehicle data indicative of a current fuel level of the vehicle is also obtained by the merchant server 4. This may be received wirelessly from a fuel sensor onboard of the vehicle, which monitors a fuel level of the vehicle. Alternatively, the vehicle data may be transmitted to the merchant server 4 by the communication device 2 which receives fuel data from the vehicle via Bluetooth™ or the like. In another possibility, the vehicle detection unit is configured to communicate with the fuel sensor to receive the fuel data and relay it to the merchant server 4.

In operation 20, the merchant server 4 interrogates a merchant database 4a to obtain a registered mobile phone number associated with the vehicle plate number. The merchant database 4a stores a predefined association between a plurality of vehicle IDs and respective mobile phone numbers. In one example, the merchant database 4a further stores a predefined association between each of the vehicle IDs and a respective fuel type by which the vehicle is powered. This information may be obtained based on past transaction records with the merchant or otherwise specified by the user.

In operation 30, the mobile phone number (or data encoding it) is transmitted to the wallet server 3 to cause it to interrogate a wallet database 3a that stores an association between one or more digital wallets of the wallet holder and a registered mobile phone number. This allows the wallet server 3 to identify wallet information associated with the registered mobile phone number using the wallet database 3a.

In one example, the wallet server 3 is configured to notify the wallet holder of a potential transaction with the merchant, for example, via an application running on the communication device 2 of the user or by a text message. This may serve as an alert notification to the user for security purposes.

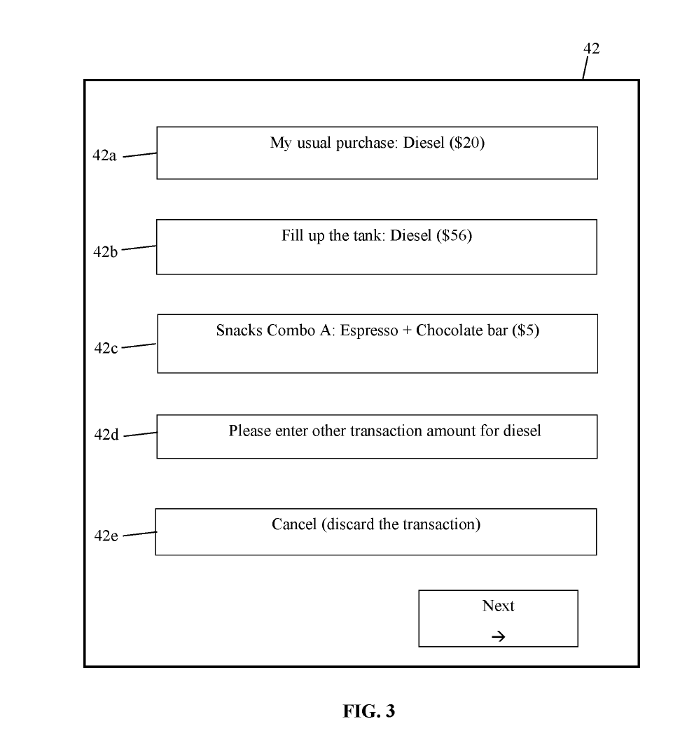

In operation 40, the merchant server 4 causes a notification to be generated automatically (i.e. without requiring manual intervention by a human subject) on the user's mobile application. In one implementation, upon detecting the vehicle at the entry and identifying the associated mobile number, the merchant server 40 sends a product list 42 to the user's application. For example, the particular user may be identified by a user's account of the application that is linked to the mobile number. The user is presented with the product list 42 of candidate product items 42a, 42b, 42c, 42d via the communication device 2 for the user's selection. An exemplary product list is shown in FIG. 3 and may be presented via an output terminal of the communication device 2 such as via a GUI. As shown, the product list 42 further comprises price information of the respective candidate product items 42a, 42b, 42c. In a variant, the product list also comprises promotional/rewards information about the candidate product items.

In this example, the candidate product item 42a is a product item recommended for the particular vehicle user based on the user's past transaction records. In other words, a product item may be determined based on past transactions with this merchant (or other merchants which offers a same category of products) and be recommended to the user. For example, for a particular consumer who may be identified by the associated mobile phone number, or the wallet information, it may be determined that the consumer made purchases of diesel of a transaction amount of $20 more frequently than other amounts based on the merchant's records. In this case, an option for the vehicle user to purchase $20 worth of diesel is included on the product list 42 as the candidate item 42a.

The candidate product item 42b is a product item recommended for the particular vehicle user based on the vehicle data (such as fuel data of the vehicle) obtained by the merchant server 4. For example, the merchant server 4 calculates a fuel amount required to fill up the vehicle's fuel tank based on the current fuel level of the vehicle. A transaction amount is calculated based on the fuel amount and presented to the user along with the suggested fuel amount.

In another example, the vehicle data may be a fuel type by which the vehicle is powered. The fuel type may be obtained by the server 4 by interrogating the merchant database 4a. In another possibility, the server 4 receives data indicative of the fuel type by reading data from a sensor of the vehicle.

The product list 42 may further include other types of products which the fuel station supplies. In particular, the product list 42 further includes a candidate item 42c which is food or beverage supplied by the fuel station.

The product list 42 has a candidate product item 42d which offers the user an option to enter a quantity of fuel he/she wish to purchase. A further option 42e which allows the user to dismiss the transaction is also made available in case the user decides not to make any purchase with the merchant.

In this example, the product list 42 may be generated by the merchant server 4 and transmitted to the communication device 2 of the user directly, for example via an mobile application provided by the merchant which is running the communication device 2.

In operation 50, the communication device 2 registers a user's selection of the one or more product items for purchase. The user's selection may be registered by the user making an active input via an input terminal, for example, by registering a user's tapping action on a touch-screen or a voice command via a microphone of the communication device 2. In some embodiments, an active input from the user may not be required. For example, in the absence of the user's action, a default candidate item (e.g. the most frequently purchased product) may be set and registered as the user's selection.

In a variant, the user is prompted to enter the product he/she wishes to purchase without being presented with a list of candidate product items.

In operation 60, the merchant server 4 receives product information of the one or more product items ordered by the user at the fuel station in response to the user's selection. Accordingly, a transaction amount may be calculated based on the user's selection.

In operation 70, the user is prompted via the communication device 2 to confirm a digital wallet from which the payment will be made. The process may include the wallet server 3 transmitting the wallet information to the user's communication device 2 and, if the user has more than one digital wallet, registering the user's selection of a digital wallet. Upon confirmation by the user, the wallet information of the selected digital wallet is transmitted to the merchant server 4.

According to a particular example, a geographic location of the communication device is additionally used for authorizing the transmission of the wallet information. Specifically, the geographic location of the communication device is verified against the merchant's geographic location and/or the vehicle's geographic location. In some embodiments, the comparison may be made by the payment network 7 as part of the payment authorization process. Usually, the geographic locations of the communication device 2 and the vehicle may be determined by their respective positioning systems such as a GPS system, a GLONASS system, a GALILEO system or a BeiDou-2 system. The merchant's geographic location may be derived based on the merchant's information such as the identity of the merchant's server.

In operation 80, a transaction request comprising details of the transaction including the wallet information of the selected digital wallet, the transaction mount and other transaction data are submitted to the payment network 7 to effect a transaction between the merchant and the vehicle user for the purchase. In one embodiment, the transaction will be effected only if the geographic locations of the communication device, the vehicle and the merchant match with one and another.

In operation 90, the relevant parties may receive confirmation from the payment network 7 evidencing that the payment transaction has been completed. The merchant server 4 may then supply the relevant products to the user.

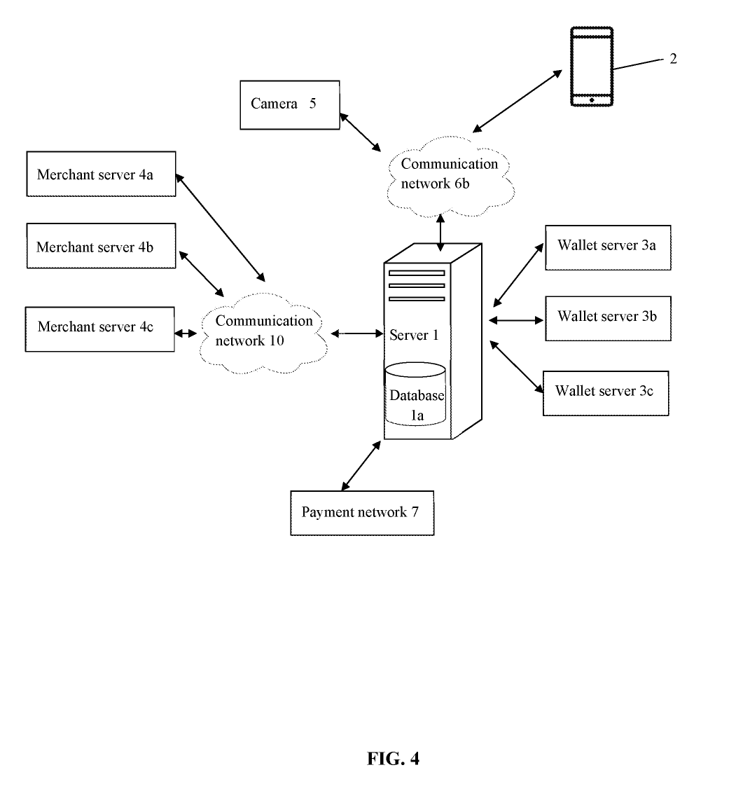

In another embodiment as shown in FIG. 4, the computerized-network may comprise a centralize server 1 which handles requests from a plurality of the communication devices (not shown) making purchase at various merchants. In this particular example, the centralized server 1 is in communication with a plurality of merchant servers 4a, 4b, 4c and a plurality of wallet servers 3a, 3b, 3c. The centralized server 1 is in communication with a payment network 7.

Similarly, the centralized server 1 is configured obtain the vehicle plate number from the camera capturing an image of the vehicle upon it entering a premise of a merchant. The centralized server 1 identifies a mobile phone number associated with the vehicle using the vehicle plate number by interrogating a database 1a which stores a predefined association between vehicle plate numbers and mobile phone numbers. Wallet information can be obtained by the centralized server 1 from the wallet servers 3a, 3b, 3c using the mobile phone number. Additionally, the centralized server may derive an identity of the merchant associated with a transaction using the geographic location of the vehicle (as the vehicle is at the merchant's premise) and cause a payment transaction to be processed at the payment network 7. During the above, the wallet information for transactions is handled by the centralized server 1, as compared to the individual merchant's servers 4a, 4b, 4c. This may minimize exposures to the security risks in handling wallet information (which could be sensitive) by the merchant's servers. Consequently, this may reduce the merchant's burden in complying with high security standards for handle sensitive information.

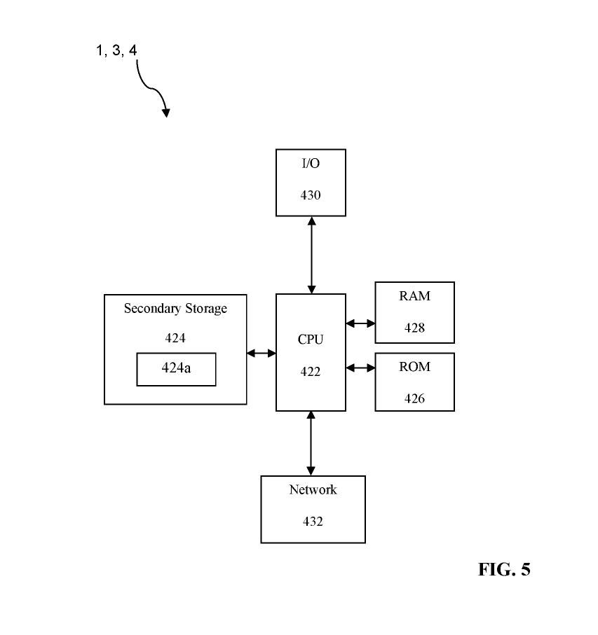

FIG. 5 is a block diagram showing a technical architecture of a server (e.g. a merchant server 4, wallet server 3 or the centralized server 1) suitable for implementing the present method.

The technical architecture includes a processor 422 (which may be referred to as a central processor unit or CPU) that is in communication with memory devices including secondary storage 424 (such as disk drives), read only memory (ROM) 426, random access memory (RAM) 428. The processor 422 may be implemented as one or more CPU chips. The technical architecture may further comprise input/output (I/O) devices 430, and network connectivity devices 432.

The secondary storage 424 is typically comprised of one or more disk drives or tape drives and is used for non-volatile storage of data and as an over-flow data storage device if RAM 428 is not large enough to hold all working data. Secondary storage 424 may be used to store programs which are loaded into RAM 428 when such programs are selected for execution.

In this embodiment, the secondary storage 424 has a processing component 424a comprising non-transitory instructions operative by the processor 422 to perform various operations of the method of the present disclosure. The ROM 426 is used to store instructions and perhaps data which are read during program execution. The secondary storage 424, the RAM 428, and/or the ROM 426 may be referred to in some contexts as computer readable storage media and/or non-transitory computer readable media.

I/O devices 430 may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 432 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 432 may enable the processor 422 to communicate with the Internet or one or more intranets. With such a network connection, it is contemplated that the processor 422 might receive information from the network, or might output information to the network in the course of performing the above-described method operations. Such information, which is often represented as a sequence of instructions to be executed using processor 422, may be received from and outputted to the network, for example, in the form of a computer data signal embodied in a carrier wave.

The processor 422 executes instructions, codes, computer programs, scripts which it accesses from hard disk, floppy disk, optical disk (these various disk based systems may all be considered secondary storage 424), flash drive, ROM 426, RAM 428, or the network connectivity devices 432. While only one processor 422 is shown, multiple processors may be present. Thus, while instructions may be discussed as executed by a processor, the instructions may be executed simultaneously, serially, or otherwise executed by one or multiple processors.

Although the technical architecture is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture to provide the functionality of a number of servers that is not directly bound to the number of computers in the technical architecture. In an embodiment, the functionality disclosed above may be provided by executing the application and/or applications in a cloud computing environment. Cloud computing may comprise providing computing services via a network connection using dynamically scalable computing resources. A cloud computing environment may be established by an enterprise and/or may be hired on an as-needed basis from a third-party provider.

It is understood that by programming and/or loading executable instructions onto the technical architecture, at least one of the CPU 422, the RAM 428, and the ROM 426 are changed, transforming the technical architecture in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

FIG. 6 is a block diagram showing a technical architecture of the communication device 2. The technical architecture includes a processor 222 (which may be referred to as a central processor unit or CPU) that is in communication with memory devices including secondary storage 224 (such as disk drives or memory cards), read only memory (ROM) 226, random access memory (RAM) 228. The processor 222 may be implemented as one or more CPU chips. The technical architecture further comprises input/output (I/O) devices 230, and network connectivity devices 232.

The I/O devices comprise a consumer interface (UI) 230a and a geolocation module 230c. The UI 230a may comprise a screen in the form of a touch screen, a keyboard, a keypad or other known input device. The geolocation module 230c is operable to determine the geolocation of the communication device using signals from, for example global positioning system (GPS) satellites.

The secondary storage 224 is typically comprised of a memory card or other storage device and is used for non-volatile storage of data and as an over-flow data storage device if RAM 228 is not large enough to hold all working data. Secondary storage 224 may be used to store programs which are loaded into RAM 228 when such programs are selected for execution.

In this embodiment, the secondary storage 224 has a processing component 224a, comprising non-transitory instructions operative by the processor 222 to perform various operations of the method of the present disclosure. The ROM 226 is used to store instructions and perhaps data which are read during program execution. The secondary storage 224, the RAM 228, and/or the ROM 226 may be referred to in some contexts as computer readable storage media and/or non-transitory computer readable media.

The network connectivity devices 232 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 232 may enable the processor 222 to communicate with the Internet or one or more intranets. With such a network connection, it is contemplated that the processor 222 might receive information from the network, or might output information to the network in the course of performing the above-described method operations. Such information, which is often represented as a sequence of instructions to be executed using processor 222, may be received from and outputted to the network, for example, in the form of a computer data signal embodied in a carrier wave.

The processor 222 executes instructions, codes, computer programs, scripts which it accesses from hard disk, floppy disk, optical disk (these various disk based systems may all be considered secondary storage 224), flash drive, ROM 226, RAM 228, or the network connectivity devices 232. While only one processor 222 is shown, multiple processors may be present. Thus, while instructions may be discussed as executed by a processor, the instructions may be executed simultaneously, serially, or otherwise executed by one or multiple processors.

Whilst the foregoing description has described exemplary embodiments, it will be understood by those skilled in the art that many variations of the embodiment can be made within the scope and spirit of the present invention. For example, communication between any two or more devices may be carried out over any suitable communication network and may be initiated by either party. The communication networks 6a, 6b, 10 may be a connected communication work. In another variant, the communication device 2 may be configured to send and receive data indirectly from the merchant server 4 and the wallet server 3.

1. A method of processing a payment transaction for a purchase carried out by a vehicle user with a merchant, the method comprising a server:
(a) obtaining a vehicle ID, from a vehicle detection unit, upon a vehicle entering a premise of the merchant;
(b) interrogating a database using the vehicle ID to obtain a device identifier associated with a communication device of the user;
(c) transmitting the device identifier to a wallet server over a communication network;
(d) receiving, upon authorization by the wallet server, over the communication network wallet information associated with a digital wallet of the user;
(e) receiving, via the communication device, product information indicative of one or more product items ordered by the user; and
(f) transmitting a transaction request to a payment network to cause a payment transaction in respect of the one or more products to be processed, said transaction request comprising the wallet information.

2. A method according to claim 1, wherein operation (e) comprises transmitting a product list comprising a plurality of candidate product items to the communication device for selection by the user, and receiving product information indicative of the one or more product items selected by the user.

3. A method according to claim 2, wherein the product list comprises price information for the respective candidate product items.

4. A method according to claim 2, wherein the candidate product items comprise a product item recommended for the vehicle user based on past transaction records.

5. A method according to claim 2, wherein the method further comprises receiving vehicle data, and the candidate product items comprise a product item recommended for the vehicle user based on the vehicle data.

6. A method according to claim 5, wherein the vehicle data is indicative of a current fuel level of the vehicle.

7. A method according to claim 5, wherein the vehicle data is indicative of a fuel type by which the vehicle is powered.

8. A method according to claim 7, wherein the database stores a predefined association between each of the vehicle IDs and a respective fuel type by which the vehicle is powered, the method comprising obtaining the fuel type associated with the vehicle using the database.

9. A method according to claim 2, wherein the candidate product items represent two or more options to purchase fuel of different quantities.

10. A method according to claim 2, wherein at least one of the candidate product items is food or beverage supplied by the merchant.

11. A method according claim 1, further comprising obtaining a geographic location of the communication device.

12. A method according to claim 11, further comprising determining if the geographic location of the communication device is consistent with a geographic location of the merchant and performing operation (f) only if the determination is positive.

13. A method according to claim 11, wherein the transaction request comprises the geographic location of the communication device.

14. A method according to claim 1, comprising generating a notification to notify the communication device upon the payment transaction being successful.

15. A method according to claim 1, wherein the device identifier is a mobile phone number.

16. A computer server for processing a payment transaction for a purchase carried out by a vehicle user with a merchant, the computer server comprising a server processor, a data storage device storing server processor program instructions, the server processor program instructions being operative to cause the server processor to:
(a) obtain a vehicle ID, from a vehicle detection unit, upon a vehicle entering a premise of the merchant;
(b) interrogate a database using the vehicle ID to obtain a device identifier associated with a communication device of the user;
(c) transmit the device identifier to a wallet server over a communication network;
(d) receive, upon authorization by the wallet server, over the communication network wallet information associated with a digital wallet of the user;
(e) receive, via the communication device, product information indicative of one or more product items ordered by the user; and
(f) transmit a transaction request to a payment network to cause a payment transaction in respect of the one or more products to be processed, said transaction request comprising the wallet information.

17. A computer server according to claim 16, wherein the server processor program instructions are operative to cause the server processor to, in operation (e), transmit a product list comprising a plurality of candidate product items to the communication device for selection by the user, and receive product information indicative of the one or more product items selected by the user.

18. A computer server according to claim 17, wherein the product list comprises price information for the respective candidate product items.

19. A computer server according to claim 17, wherein the candidate product items comprise a product item recommended for the vehicle user based on past transaction records.

20. A computer server according to claim 17, wherein the server processor program instructions are operative to cause the server processor to receive vehicle data and the candidate product items comprises a product item recommended for the vehicle user based on the vehicle data.

21. A computer server according to claim 17, wherein the server processor program instructions are operative to cause the server processor to obtain a geographic location of the communication device.

22. A computer server according to claim 21, wherein the server processor program instructions are operative to cause the server processor to determine if the geographic location of the communication device is consistent with a geographic location of the merchant and to perform operation (f) only if the determination is positive.

23. A computer server according to claim 21, wherein the transaction request comprises the geographic location of the communication device.

24. A method according to claim 16, wherein the device identifier is a mobile phone number.

25. A method of making a payment for a purchase carried out by a vehicle user with a merchant, the method comprising a communication device of the vehicle user, upon a vehicle ID having been obtained at a premise of the merchant:
(a) receiving, from a wallet server, wallet data identifying one or more digital wallets associated with the vehicle user;
(b) registering a wallet selection from the one or more digital wallets and causing wallet information associated with the selected wallet to be transmitted to a server of the merchant;
(c) registering one or more product items ordered by the user, and
(d) transmitting the one or more product items to the merchant's server to initiate a payment transaction for the one or more product items using the selected wallet.

26. A method according to claim 25, wherein operation (b) further comprises authorizing the wallet server to transmit the wallet information to the merchant's server upon authentication by the user.

27. A method according to claim 25, wherein operation (c) comprises receiving a product list comprising a plurality of candidate product items for selection by the user, and registering the one or more product items selected by the user.

28. A method according to claim 27, wherein the product list comprises price information for the respective candidate product items.

29. A method according to claim 27, wherein the candidate product items comprise a product item recommended for the vehicle user based on past transaction records.

30. A method according to claim 26, wherein the candidate product items comprise a product item recommended for the vehicle user based on a current fuel level of the vehicle.

31. A method according to claim 30, comprising receiving fuel data indicative of the current fuel level of the vehicle from the vehicle and transmitting the fuel data to the merchant's server.

32. A method according to claim 27, wherein the candidate product items represent two or more options to purchase fuel of different quantities.

33. A method according to claim 27, wherein the candidate product items represent two or more options to purchase fuel of different types.

34. A method according to claim 27, wherein at least one of the candidate product items is food or beverage supplied by the merchant.

35. A method according to claim 26, wherein operation (b) further comprises causing the wallet information to be transmitted upon a geographic location of the communication device being successfully verified against a geographic location of the merchant.

36. A communication device for making a payment for a purchase carried out by a vehicle user with a merchant, the communication device comprising a processor and a data storage device storing program instructions,
the computer program instructions being operative to cause the processor to, upon a vehicle ID having been obtained at a premise of the merchant:
(a) receive, from a wallet server, wallet data identifying one or more digital wallets associated with the vehicle user;
(b) register a wallet selection from the one or more digital wallets and cause wallet information associated with the selected wallet to be transmitted to a server of the merchant;
(c) register one or more product items ordered by the user, and
(d) transmit the one or more product items to the merchant's server to initiate a payment transaction for the one or more product items using the selected wallet.

37. A communication device according to claim 36, wherein the computer program instructions are operative to cause the processor to, in operation (b), authorize the wallet server to transmit the wallet information to the merchant's server upon authentication by the user.

38. A communication device according to claim 36, wherein the computer program instructions are operative to cause the processor to, in operation (b), cause the wallet information to be transmitted upon a geographic location of the communication device being successfully verified against a geographic location of the merchant.
